(19) United States
(12) Patent Application Publication
(10) Pub. No.: US 2018/0279651 A1
(43) Pub. Date: Oct. 4, 2018

(54) FEED COMPOSITION

(71) Applicant: NISSO FINE CO., LTD., Tokyo (JP)

(72) Inventors: Toyohito Sakurai, Kitaibaraki-shi (JP); Hiroyuki Kushida, Kitaibaraki-shi (JP)

(73) Assignee: NISSO FINE CO., LTD., Tokyo (JP)

(21) Appl. No.: 15/766,253

(22) PCT Filed: Oct. 7, 2016
(86) PCT No.: PCT/JP2016/079888

§ 371 Date: Apr. 5, 2018

(30) Foreign Application Priority Data
Oct. 8, 2015 (JP) 2015-200158

(51) Int. Cl. A23K 20/158; A23K 20/142; A23K 50/10

(52) U.S. Cl. CPC A23K 20/158; A23K 50/10; A23K 20/142

(57) ABSTRACT

A feed composition is prepared by a method comprising mixing an amino acid such as methionine or lysine; a fatty acid metal salt such as calcium oleate, calcium myristate, calcium palmitate, calcium stearate, or calcium linoleate; a fatty acid such as lauric acid, stearic acid, myristic acid, palmitic acid, oleic acid, or linoleic acid; and a sorbitan fatty acid ester such as sorbitan trioleate, and shaping the resulting mixture, wherein the sorbitan fatty acid ester has an HLB of not more than 3.

### TECHNICAL FIELD

The present invention relates to a feed composition. More specifically, the present invention relates to a feed composition having hardly elution of amino acid in stomach (excellent rumen bypass properties) and easily elution of amino acid in small intestine (excellent enteric properties) and being useful as feed for ruminants, such as cattle, sheep, and goats.

### BACKGROUND ART

In livestock raising, it is required to efficiently give intended amino acids to the livestock without giving extra nutrients. For example, it is important to supply amino acids, such as methionine and lysine, to dairy cattle for enhancing secretion of good milk. Amino acids are mainly absorbed by small intestine. However, amino acids are apt to be broken down in stomach (in cattle, e.g., first stomach (rumen)) before reaching the small intestine. Accordingly, techniques for preventing amino acids from being broken down in the stomach have been researched.

For example, Patent Document 1 suggests a method for producing a feed composition comprising mixing a fatty acid and a protein or amino acid, then mixing the mixture with a metal compound, and finally mixing the mixed product with a surfactant and water. This method seems to generate a fatty acid metal salt in the feed composition through a reaction between the fatty acid and the metal compound.

Patent Document 2 discloses an approximately cylindrical rumen bypass preparation produced by melt extrusion of a mixture of a tallow acid calcium salt, palmitic acid, and methionine with a twin-screw extrusion granulator.

### CITATION LIST

### Patent Literatures

Patent Document 1 : JP H09-299038 A

Patent Document 2 : JP H10-215789 A

### SUMMARY OF THE INVENTION

### Problems to be Solved by the Invention

Even though the rumen bypass properties of an amino acid are improved, the amino acid is not sufficiently supplied to livestock if the amino acid is insufficiently absorbed by small intestine with weakly basic condition.

An object of the present invention is to provide a feed composition having hardly elution of amino acid in stomach (that is excellent rumen bypass properties) and easily elution of amino acid in small intestine (that is excellent enteric properties) and being useful as feed for ruminants, such as cattle, sheep, and goats.

### Means for Solving the Problems

Diligent studies to solve the problems result in a completion of the present invention including the following aspects.

The present invention encompasses the following aspects.
[1] A feed composition comprising an amino acid, a fatty acid metal salt, a fatty acid, and a sorbitan fatty acid ester, wherein the sorbitan fatty acid ester has a hydrophile-lipophile balance (HLB) of not more than 3.
[2] The feed composition according to aspect [1], wherein the amino acid is at least one selected from the group consisting of methionine and lysine.
[3] The feed composition according to aspect [1] or [2], wherein the fatty acid metal salt is at least one selected from the group consisting of calcium oleate, calcium myristate, calcium palmitate, calcium stearate, and calcium linoleate.
[4] The feed composition according to any one of aspects [1] to [3], wherein the fatty acid is at least one selected from the group consisting of lauric acid, stearic acid, myristic acid, palmitic acid, oleic acid, and linoleic acid.
[5] The feed composition according to any one of aspects [1] to [4], wherein the sorbitan fatty acid ester having an HLB of not more than 3 is sorbitan trioleate.
[6] The feed composition according to any one of aspects [1] to [5], wherein an amount of the amino acid is 10 to 80 parts by mass relative to 100 parts by mass of the feed composition.
[7] The feed composition according to any one of aspects [1] to [6], wherein an amount of the fatty acid is 1 to 20 parts by mass relative to 100 parts by mass of the feed composition.
[8] The feed composition according to any one of aspects [1] to [7], wherein an amount of the sorbitan fatty acid ester having an HLB of not more than 3 is 0.1 to 30 parts by mass relative to 100 parts by mass of the feed composition.
[9] The feed composition according to any one of aspects [1] to [5], wherein an amount of the fatty acid metal salt is 10 to 60 parts by mass relative to 100 parts by mass of the feed composition.
[10] A method for producing a feed composition, comprising mixing an amino acid, a fatty acid metal salt, a fatty acid and a sorbitan fatty acid ester, and shaping the resulting mixture, wherein the sorbitan fatty acid ester has an HLB of not more than 3.

### Advantageous Effects of the Invention

The feed composition of the present invention has hardly elution of amino acids in stomach (that is excellent rumen bypass properties) and easily elution of amino acids in small intestine (that is excellent enteric properties).

The feed composition of the present invention can be prepared by mixing an amino acid, a fatty acid metal salt, a fatty acid, and a sorbitan fatty acid ester having an HLB of not more than 3, and shaping the resulting mixture.

The feed composition of the present invention not only can be used as feed for ruminants such as cattle, sheep and goats but also can be used as feed for hatchery fish such as sea bream and yellowtail, or domestic fowls such as chicken.

### EMBODIMENTS FOR CARRYING OUT THE INVENTION

The feed composition of the present invention comprises an amino acid, a fatty acid metal salt, a fatty acid, and a sorbitan fatty acid ester.

The amino acid used in the present invention is not limited as long as it functions as a nutrient for an animal to be raised. In particular, the amino acid is preferably at least one selected from the group consisting of methionine and lysine. The amino acid used in the present invention may be bonded to each other, i.e., may be in a protein form.

The amount of the amino acid comprised in the feed composition of the present invention is preferably 10 to 80 parts by mass, more preferably 40 to 80 parts by mass, relative to 100 parts by mass of the feed composition.

The fatty acid metal salt used in the present invention is not limited as long as it is known for industrial use or feed use. The fatty acid metal salt may be synthesized by a reaction between a fatty acid and a metal compound or may be a commercial product. As the commercial product, mentioned can be a fatty acid calcium salt (product name: “Megalac”) and the like. The fatty acid metal salt is preferably a metal salt known as minerals, such as an aluminum salt, a calcium salt, a magnesium salt, a barium salt, an iron salt, and a zinc salt. Among the fatty acid metal salts, preferred is at least one selected from the group consisting of calcium oleate, calcium myristate, calcium palmitate, calcium stearate, and calcium linoleate.

The amount of the fatty acid metal salt comprised in the feed composition of the present invention is preferably 10 to 60 parts by mass, more preferably 10 to 30 parts by mass, relative to 100 parts by mass of the feed composition.

The fatty acid used in the present invention is not limited as long as it is known for industrial us or feed use. In particular, the fatty acid is preferably a higher fatty acid and is more preferably at least one selected from the group consisting of lauric acid, stearic acid, myristic acid, palmitic acid, oleic acid, and linoleic acid.

The amount of the fatty acid comprised in the feed composition of the present invention is preferably 1 to 20 parts by mass, more preferably 1 to 10 parts by mass, relative to 100 parts by mass of the feed composition.

The sorbitan fatty acid ester used in the present invention has an HLB of not more than 3. The HLB can be calculated by “Nyuka Shiken niyoru HLB no Sokuteiho (Method for measuring HLB by emulsification test)” described in “Kaimen Kasseizai no Seishitsu to Oyo (Properties and Application of Surfactants)” (written by Takao Kariyone, Published by Saiwai Shobo on Sep. 1, 1980), pp. 89-90. The sorbitan fatty acid ester is an ester compound composed of sorbitan and fatty acid. Sorbitan is compounds prepared by a dehydration reaction of sorbitol. The dehydration reaction of sorbitol gives a plurality of compounds. The sorbitan may be a mixture of such compounds. The sorbitan may contain 1,4-anhydrosorbitol, 1,5-anhydrosorbitol, 1,4,3,6-dianhydrosorbitol and the like. The fatty acid employed in the sorbitan fatty acid ester is preferably a fatty acid having 18 carbon atoms, such as oleic acid and stearic acid.

### <Method for Measuring HLB by Emulsification Test>

A sorbitan fatty acid ester (X) whose HLB is unknown and an emulsifier (A) whose HLB is known are mixed at various ratios, and an oil solution whose HLB is known is emulsified. A mixing ratio giving the maximum thickness of the emulsified layer is determined, and the HLB of the sorbitan fatty acid ester (X) is calculated from the mixing ratio using the following expression:

(HLB of oil solution)=[(W_{A}×HLB_{A})+(W_{X}×HLB_{X})]/(W_{A}+W_{X})

where W_{A} represents the weight fraction of the emulsifier (A) for the total weight of the sorbitan fatty acid ester (X) and the emulsifier (A); W_{X} represents the weight fraction of the sorbitan fatty acid ester (X) for the total weight of the sorbitan fatty acid ester (X) and the emulsifier (A); HLB_{A} represents the HLB of the emulsifier (A); and HLB_{X} represents the HLB of the sorbitan fatty acid ester (X).

A sorbitan fatty acid ester having an HLB of not more than 3 is usually hardly dispersed in water and is usually used as, for example, an antifoaming agent. The sorbitan fatty acid ester having an HLB of not more than 3 may be a mixture of heterologous sorbitan fatty acid esters. The sorbitan fatty acid ester used in the present invention is preferably sorbitan trioleate having an HLB of not more than 3.

The amount of the sorbitan fatty acid ester having an HLB of not more than 3 comprised in the feed composition of the present invention is preferably 0.1 to 30 parts by mass, more preferably 0.5 to 10 parts by mass, relative to 100 parts by mass of the feed composition.

The feed composition of the present invention may comprise an additive that can be contained in known feed. Examples of the additive include waxes or solders such as rice wax, carnauba wax, beeswax and the like; ethyl cellulose, propyl cellulose, polyethylene, chitosan, and derivatives thereof; inorganic powder; stabilizers; essences and the like.

The feed composition of the present invention can be shaped into, for example, powder, granules, tablets, pellets, or briquettes. Examples of the shaping method include extrusion, spray drying, fluidized granulation, stirring granulation, pan granulation and the like. Among them, extrusion is preferred. Shaping of the feed composition can provide, for example, cylindrical granules having an average diameter of 0.5 to 3 mm and an average length of 0.5 to 4 mm.

The present invention will now be described in more detail by examples. The following examples are merely illustrative for explanation, and the scope of the present invention is not limited to these examples.

Rumen bypass properties and enteric properties of a feed composition were evaluated by the following method.

### [Simulated Rumen Fluid]

In water, 2.5 g of disodium hydrogen phosphate and 6.7 g of potassium dihydrogen phosphate were dissolved to obtain 1000 mL of an aqueous solution having pH of 6.4. This aqueous solution was used as simulated rumen fluid.

### [Simulated Abomasum Fluid]

In about 1000 mL of pure water, 7.45 g of potassium chloride was dissolved and 106 ml of 1/5 N hydrochloric acid and water were added to obtain 2000 mL of an aqueous solution having pH of 2.0. This aqueous solution was used as simulated abomasum fluid.

### [Simulated Small Intestinal Fluid]

In water, 1.60 g of calcium chloride, 18.80 g of sodium chloride, 4.80 g of magnesium sulfate heptahydrate and 22.80 g of potassium chloride were dissolved to obtain 1000 mL of a solution A. To 50 ml of the solution A, a solution B and a solution C were added to obtain 2000 mL of a solution D. The solution B is produced by adding 18.6 g of disodium hydrogen phosphate 12-water in about 100 mL of water and heating the resulting mixture for dissolving. The solution C is produced by dissolving 19.6 g of sodium hydrogen carbonate in water. The solution D was heated up to 50° C. while stirring. In the resulting solution, 1.0 g of bile powder and 1.0 g of lipase were added and dissolved to obtain an aqueous solution having pH of 8.3. This aqueous solution was used as simulated small intestinal fluid.

### [Elution Ratio in Rumen Fluid]

In 200 mL of the simulated rumen fluid, 1.0 g of feed composition was immersed at 40° C. on shaking for 16 hours. Solid content was separated by percolation, and the colature was titrated with a sodium thiosulfate solution to determine a mass of methionine contained in the colature. The ratio of the mass of methionine contained in the colature to the mass of methionine contained in the feed composition was calculated.

### [Elution Ratio in Abomasum Fluid]

In 200 mL of the simulated abomasum fluid, the solid content separated from the simulated rumen fluid by the percolation was immersed at 40° C. on shaking for 2 hours. Solid content was separated by filtration, and the filtrate was titrated with a sodium thiosulfate solution to determine a mass of methionine contained in the filtrate. The ratio of the mass of methionine contained in the filtrate to the mass of methionine contained in the feed composition was calculated.

### [Elution Ratio in Small Intestinal Fluid]

In 200 mL of the simulated small intestinal fluid, the solid content separated from the simulated abomasum fluid by the filtration was immersed at 40° C. on shaking 4 hours. Solid content was separated by filtering, and the filtered liquid was titrated with a sodium thiosulfate solution to determine a mass of methionine contained in the filtered liquid. The ratio of the mass of methionine contained in the filtered liquid to the mass of methionine contained in the feed composition was calculated.

Smaller elution ratios in rumen fluid and abomasum fluid indicate more excellent rumen bypass properties. Larger elution ratio in small intestinal fluid indicates more excellent enteric properties.

### EXAMPLE 1

In a mortar, 6.960 g of DL-methionine, 0.671 g of a fatty acid (a mixture of 75% by mass of lauric acid and 25% by mass of stearic acid), 2.169 g of a fatty acid metal salt (product name: “Megalac”), and 0.200 g of sorbitan trioleate having an HLB of 1.8 were homogeneously mixed. The resulting mixture was heated to 120° C. The mixture of 120° C. was placed on a screen having an opening of 1.5 mmΦ and was pressed with a spatula for passing through the screen to obtain a granular feed composition. The granular feed composition was tested for rumen bypass properties and enteric properties. The elution ratio in rumen fluid was 12%, the elution ratio in abomasum fluid was 14%, the sum of the elution ratio in rumen fluid and the elution ratio in abomasum fluid was 26%, and the elution ratio in small intestinal fluid was 35%.

### EXAMPLE 2

A granular feed composition was obtained in the same manner as in Example 1 except that the amount of the fatty acid metal salt (product name: “Megalac”) was changed to 2.319 g and the amount of the sorbitan trioleate having an HLB of 1.8 was changed to 0.050 g. The granular feed composition was tested for rumen bypass properties and enteric properties. The elution ratio in rumen fluid was 27%, the elution ratio in abomasum fluid was 30%, the sum of the elution ratio in rumen fluid and the elution ratio in abomasum fluid was 57%, and the elution ratio in small intestinal fluid was 29%.

### EXAMPLE 3

A granular feed composition was obtained in the same manner as in Example 1 except that the amount of the fatty acid metal salt (product name: “Megalac”) was changed to 1.369 g and the amount of the sorbitan trioleate having an HLB of 1.8 was changed to 1.000 g. The granular feed composition was tested for rumen bypass properties and enteric properties. The elution ratio in rumen fluid was 7%, the elution ratio in abomasum fluid was 9%, the sum of the elution ratio in rumen fluid and the elution ratio in abomasum fluid was 16%, and the elution ratio in small intestinal fluid was 50%.

### EXAMPLE 4

A granular feed composition was obtained in the same manner as in Example 1 except that the amount of the fatty acid metal salt (product name: “Megalac”) was changed to 2.274 g and the amount of the sorbitan trioleate having an HLB of 1.8 was changed to 0.095 g. The granular feed composition was tested for rumen bypass properties and enteric properties. The elution ratio in rumen fluid was 19%, the elution ratio in abomasum fluid was 23%, the sum of the elution ratio in rumen fluid and the elution ratio in abomasum fluid was 42%, and the elution ratio in small intestinal fluid was 31%.

### EXAMPLE 5

A granular feed composition was obtained in the same manner as in Example 1 except that the amount of the fatty acid metal salt (product name: “Megalac”) was changed to 1.769 g and the amount of the sorbitan trioleate having an HLB of 1.8 was changed to 0.600 g. The granular feed composition was tested for rumen bypass properties and enteric properties. The elution ratio in rumen fluid was 13%, the elution ratio in abomasum fluid was 13%, the sum of the elution ratio in rumen fluid and the elution ratio in abomasum fluid was 26%, and the elution ratio in small intestinal fluid was 45%.

### COMPARATIVE EXAMPLE 1

A granular feed composition was obtained in the same manner as in Example 1 except that the amount of the fatty acid metal salt (product name: “Megalac”) was changed to 2.369 g and the amount of the sorbitan trioleate was changed to 0 g. The granular feed composition was tested for rumen bypass properties and enteric properties. The elution ratio in rumen fluid was 29%, the elution ratio in abomasum fluid was 31%, the sum of the elution ratio in rumen fluid and the elution ratio in abomasum fluid was 60%, and the elution ratio in small intestinal fluid was 26%.

### COMPARATIVE EXAMPLE 2

A granular feed composition was obtained in the same manner as in Example 4 except that the sorbitan trioleate having an HLB of 1.8 was changed to sorbitan monooleate having an HLB of 4.3. The granular feed composition was tested for rumen bypass properties and enteric properties. The elution ratio in rumen fluid was 47%, the elution ratio in abomasum fluid was 22%, the sum of the elution ratio in rumen fluid and the elution ratio in abomasum fluid was 69%, and the elution ratio in small intestinal fluid was 28%.

### COMPARATIVE EXAMPLE 3

A granular feed composition was obtained in the same manner as in Example 4 except that the sorbitan trioleate having an HLB of 1.8 was changed to sorbitan monolaurate having an HLB of 8.6. The granular feed composition was tested for rumen bypass properties and enteric properties. The elution ratio in rumen fluid was 62%, the elution ratio in abomasum fluid was 7%, the sum of the elution ratio in rumen fluid and the elution ratio in abomasum fluid was 69%, and the elution ratio in small intestinal fluid was 23%.

### EXAMPLE 6

In a mortar, 6.960 g of DL-methionine, 0.671 g of a fatty acid (a mixture of 75% by mass of lauric acid and 25% by mass of stearic acid), 1.769 g of a fatty acid metal salt (product name: “Megalac”) and 0.600 g of sorbitan tristearate having an HLB of 2.1 were homogeneously mixed. The resulting mixture was heated to 120° C. The mixture of 120° C. was placed on a screen having an opening of 1.5 mmΦ and was pressed with a spatula for passing through the screen to obtain a granular feed composition. The granular feed composition was tested for rumen bypass properties and enteric properties. The elution ratio in rumen fluid was 15%, the elution ratio in abomasum fluid was 17%, the sum of the elution ratio in rumen fluid and the elution ratio in abomasum fluid was 32%, and the elution ratio in small intestinal fluid was 42%.

### EXAMPLE 7

A granular feed composition was obtained in the same manner as in Example 6 except that the amount of the fatty acid metal salt (product name: “Megalac”) was changed to 1.369 g and the amount of the sorbitan tristearate having an HLB of 2.1 was changed to 1.000 g. The granular feed composition was tested for rumen bypass properties and enteric properties. The elution ratio in rumen fluid was 8%, the elution ratio in abomasum fluid was 10%, the sum of the elution ratio in rumen fluid and the elution ratio in abomasum fluid was 18%, and the elution ratio in small intestinal fluid was 47%.

### EXAMPLE 8

A granular feed composition was obtained in the same manner as in Example 6 except that the amount of the fatty acid metal salt (product name: “Megalac”) was changed to 1.969 g and the amount of the sorbitan tristearate having an HLB of 2.1 was changed to 0.400 g. The granular feed composition was tested for rumen bypass properties and enteric properties. The elution ratio in rumen fluid was 19%, the elution ratio in abomasum fluid was 20%, the sum of the elution ratio in rumen fluid and the elution ratio in abomasum fluid was 39%, and the elution ratio in small intestinal fluid was 37%.

### EXAMPLE 9

A granular feed composition was obtained in the same manner as in Example 6 except that the amount of the fatty acid metal salt (product name: “Megalac”) was changed to 1.569 g and the amount of the sorbitan tristearate having an HLB of 2.1 was changed to 0.800 g. The granular feed composition was tested for rumen bypass properties and enteric properties. The elution ratio in rumen fluid was 12%, the elution ratio in abomasum fluid was 16%, the sum of the elution ratio in rumen fluid and the elution ratio in abomasum fluid was 28%, and the elution ratio in small intestinal fluid was 45%.

### EXAMPLE 10

In a mortar, 6.960 g of DL-methionine, 0.671 g of a fatty acid (a mixture of 75% by mass of lauric acid and 25% by mass of stearic acid), 1.769 g of a fatty acid metal salt (product name: “Megalac”), and 0.600 g of sorbitan trioleate having an HLB of 3.0 were homogeneously mixed. The resulting mixture was heated to 120° C. The mixture of 120° C. was placed on a screen having an opening of 1.5 mmΦ and was pressed with a spatula for passing through the screen to obtain a granular feed composition. The granular feed composition was tested for rumen bypass properties and enteric properties. The elution ratio in rumen fluid was 19%, the elution ratio in abomasum fluid was 23%, the sum of the elution ratio in rumen fluid and the elution ratio in abomasum fluid was 42%, and the elution ratio in small intestinal fluid was 35%.

### EXAMPLE 11

A granular feed composition was obtained in the same manner as in Example 10 except that the amount of the fatty acid metal salt (product name: “Megalac”) was changed to 1.569 g and the amount of the sorbitan trioleate having an HLB of 3.0 was changed to 0.800 g. The granular feed composition was tested for rumen bypass properties and enteric properties. The elution ratio in rumen fluid was 15%, the elution ratio in abomasum fluid was 22%, the sum of the elution ratio in rumen fluid and the elution ratio in abomasum fluid was 37%, and the elution ratio in small intestinal fluid was 37%.

### EXAMPLE 12

A granular feed composition was obtained in the same manner as in Example 10 except that the amount of the fatty acid metal salt (product name: “Megalac”) was changed to 1.969 g and the amount of the sorbitan trioleate having an HLB of 3.0 was changed to 0.400 g. The granular feed composition was tested for rumen bypass properties and enteric properties. The elution ratio in rumen fluid was 23%, the elution ratio in abomasum fluid was 26%, the sum of the elution ratio in rumen fluid and the elution ratio in abomasum fluid was 49%, and the elution ratio in small intestinal fluid was 32%.

### EXAMPLE 13

A granular feed composition was obtained in the same manner as in Example 10 except that the amount of the fatty acid metal salt (product name: “Megalac”) was changed to 1.369 g and the amount of the sorbitan trioleate having an HLB of 3.0 was changed to 1.000 g. The granular feed composition was tested for rumen bypass properties and enteric properties. The elution ratio in rumen fluid was 12%, the elution ratio in abomasum fluid was 19%, the sum of the elution ratio in rumen fluid and the elution ratio in abomasum fluid was 31%, and the elution ratio in small intestinal fluid was 40%.

### EXAMPLE 14

In a mortar, 6.960 g of DL-methionine, 0,671 g of a fatty acid (a mixture of 75% by mass of lauric acid and 25% by mass of stearic acid), 2.169 g of a fatty acid metal salt (product name: “Megalac”) and 0.200 g of sorbitan tristearate having an HLB of 3.0 were homogeneously mixed. The resulting mixture was heated to 120° C. The mixture of 120° C. was placed on a screen having an opening of 1.5 mmΦ and was pressed with a spatula for passing through the screen to obtain a granular feed composition. The granular feed composition was tested for rumen bypass properties and enteric properties. The elution ratio in rumen fluid was 25%, the elution ratio in abomasum fluid was 30%, the sum of the elution ratio in rumen fluid and the elution ratio in abomasum fluid was 55%, and the elution ratio in small intestinal fluid was 30%.

### EXAMPLE 15

A granular feed composition was obtained in the same manner as in Example 14 except that the amount of the fatty acid metal salt (product name: “Megalac”) was changed to 1.569 g and the amount of the sorbitan tristearate having an HLB of 3.0 was changed to 0.800 g. The granular feed composition was tested for rumen bypass properties and enteric properties. The elution ratio in rumen fluid was 17%, the elution ratio in abomasum fluid was 20%, the sum of the elution ratio in rumen fluid and the elution ratio in abomasum fluid was 37%, and the elution ratio in small intestinal fluid was 38%.

### EXAMPLE 16

A granular feed composition was obtained in the same manner as in Example 14 except that the amount of the fatty acid metal salt (product name: “Megalac”) was changed to 1.969 g and the amount of the sorbitan tristearate having an HLB of 3.0 was changed to 0.400 g. The granular feed composition was tested for rumen bypass properties and enteric properties. The elution ratio in rumen fluid was 24%, the elution ratio in abomasum fluid was 27%, the sum of the elution ratio in rumen fluid and the elution ratio in abomasum fluid was 51%, and the elution ratio in small intestinal fluid was 32%.

### EXAMPLE 17

A granular feed composition was obtained in the same manner as in Example 14 except that the amount of the fatty acid metal salt (product name: “Megalac”) was changed to 1.769 g and the amount of the sorbitan tristearate having an HLB of 3.0 was changed to 0.600 g. The granular feed composition was tested for rumen bypass properties and enteric properties. The elution ratio in rumen fluid was 20%, the elution ratio in abomasum fluid was 22%, the sum of the elution ratio in rumen fluid and the elution ratio in abomasum fluid was 42%, and the elution ratio in small intestinal fluid was 36%.

### EXAMPLE 18

A granular feed composition was obtained in the same manner as in Example 14 except that the amount of the fatty acid metal salt (product name: “Megalac”) was changed to 1.369 g and the amount of the sorbitan tristearate having an HLB of 3.0 was changed to 1.000 g. The granular feed composition was tested for rumen bypass properties and enteric properties. The elution ratio in rumen fluid was 14%, the elution ratio in abomasum fluid was 20%, the sum of the elution ratio in rumen fluid and the elution ratio in abomasum fluid was 34%, and the elution ratio in small intestinal fluid was 41%.

### EXAMPLE 19

In a mortar, 8.000 g of DL-methionine, 0.671 g of a fatty acid (a mixture of 75% by mass of lauric acid and 25% by mass of stearic acid), 1.234 g of a fatty acid metal salt (product name: “Megalac”), and 0.095 g of sorbitan trioleate having an HLB of 1.8 were homogeneously mixed. The resulting mixture was heated to 120° C. The mixture of 120° C. was placed on a screen having an opening of 1.5 mmΦ and was pressed with a spatula for passing through the screen to obtain a granular feed composition. The granular feed composition was tested for rumen bypass properties and enteric properties. The elution ratio in rumen fluid was 8%, the elution ratio in abomasum fluid was 50%, the sum of the elution ratio in rumen fluid and the elution ratio in abomasum fluid was 58%, and the elution ratio in small intestinal fluid was 29%.

### EXAMPLE 20

A granular feed composition was obtained in the same manner as in Example 19 except that the amount of the fatty acid metal salt (product name: “Megalac”) was changed to 1.129 g and the amount of the sorbitan trioleate having an HLB of 1.8 was changed to 0.200 g. The granular feed composition was tested for rumen bypass properties and enteric properties. The elution ratio in rumen fluid was 5%, the elution ratio in abomasum fluid was 39%, the sum of the elution ratio in rumen fluid and the elution ratio in abomasum fluid was 44%, and the elution ratio in small intestinal fluid was 35%.

### EXAMPLE 21

In a blender, 139.2 kg of DL-methionine, 13.42 kg of a fatty acid (a mixture of 75% by mass of lauric acid and 25% by mass of stearic acid) and 45.48 kg of a fatty acid metal salt (product name: “Megalac”) were mixed. To the mixture, 1.90 kg of sorbitan trioleate having an HLB of 1.8 was gradually added, while mixing with a ribbon mixer at room temperature for 60 minutes. The resulting mixture was heated to 150° C. and was extruded through a twin-screw extruder to obtain a granular feed composition. The granular feed composition was tested for rumen bypass properties and enteric properties. The elution ratio in rumen fluid was 14%, the elution ratio in abomasum fluid was 5%, the sum of the elution ratio in rumen fluid and the elution ratio in abomasum fluid was 19%, and the elution ratio in small intestinal fluid was 50%.

### EXAMPLE 22

A granular feed composition was obtained in the same manner as in Example 21 except that the amount of the fatty acid metal salt (product name: “Megalac”) was changed to 43.38 kg and the amount of the sorbitan trioleate having an HLB of 1.8 was changed to 4.00 kg. The granular feed composition was tested for rumen bypass properties and enteric properties. The elution ratio in rumen fluid was 19%, the elution ratio in abomasum fluid was 18%, the sum of the elution ratio in rumen fluid and the elution ratio in abomasum fluid was 37%, and the elution ratio in small intestinal fluid was 38%.

### EXAMPLE 23

A granular feed composition was obtained in the same manner as in Example 21 except that the amount of the fatty acid metal salt (product name: “Megalac”) was changed to 37.38 kg and the amount of the sorbitan trioleate having an HLB of 1.8 was changed to 10.00 kg. The granular feed composition was tested for rumen bypass properties and enteric properties. The elution ratio in rumen fluid was 8%, the elution ratio in abomasum fluid was 6%, the sum of the elution ratio in rumen fluid and the elution ratio in abomasum fluid was 14%, and the elution ratio in small intestinal fluid was 48%.

### EXAMPLE 24

A granular feed composition was obtained in the same manner as in Example 21 except that the amount of the fatty acid metal salt (product name: “Megalac”) was changed to 41.38 kg and the amount of the sorbitan trioleate having an HLB of 1.8 was changed to 6.00 kg. The granular feed composition was tested for rumen bypass properties and enteric properties. The elution ratio in rumen fluid was 12%, the elution ratio in abomasum fluid was 10%, the sum of the elution ratio in rumen fluid and the elution ratio in abomasum fluid was 22%, and the elution ratio in small intestinal fluid was 46%.

### EXAMPLE 25

A granular feed composition was obtained in the same manner as in Example 21 except that the amount of the fatty acid metal salt (product name: “Megalac”) was changed to 39.38 kg and the amount of the sorbitan trioleate having an HLB of 1.8 was changed to 8.00 kg. The granular feed composition was tested for rumen bypass properties and enteric properties. The elution ratio in rumen fluid was 10%, the elution ratio in abomasum fluid was 8%, the sum of the elution ratio in rumen fluid and the elution ratio in abomasum fluid was 18%, and the elution ratio in small intestinal fluid was 46%.

### COMPARATIVE EXAMPLE 4

A granular feed composition was obtained in the same manner as in Example 21 except that the amount of the fatty acid metal salt (product name: “Megalac”) was changed to 47.38 kg and that the amount of the sorbitan trioleate was changed to 0.00 kg. The granular feed composition was tested for rumen bypass properties and enteric properties. The elution ratio in rumen fluid was 15%, the elution ratio in abomasum fluid was 17%, the sum of the elution ratio in rumen fluid and the elution ratio in abomasum fluid was 32%, and the elution ratio in small intestinal fluid was 35%.

### EXAMPLE 26

In a blender, 139.2 kg of DL-methionine, 13.42 kg of a fatty acid (a mixture of 75% by mass of lauric acid and 25% by mass of stearic acid) and 45.48 kg of a fatty acid metal salt (product name: “Megalac”) were mixed. To the mixture, 1.90 kg of sorbitan tristearate having an HLB of 2.1 was gradually added, while mixing with a ribbon mixer at room temperature for 60 minutes. The resulting mixture was heated to 150° C. and was extruded through a twin-screw extruder to obtain a granular feed composition. The granular feed composition was tested for rumen bypass properties and enteric properties. The elution ratio in rumen fluid was 14%, the elution ratio in abomasum fluid was 10%, the sum of the elution ratio in rumen fluid and the elution ratio in abomasum fluid was 24%, and the elution ratio in small intestinal fluid was 46%.

### EXAMPLE 27

A granular feed composition was obtained in the same manner as in Example 26 except that the amount of the fatty acid metal salt (product name: “Megalac”) was changed to 41.38 kg and the amount of the sorbitan tristearate having an HLB of 2.1 was changed to 6.00 kg. The granular feed composition was tested for rumen bypass properties and enteric properties. The elution ratio in rumen fluid was 14%, the elution ratio in abomasum fluid was 12%, the sum of the elution ratio in rumen fluid and the elution ratio in abomasum fluid was 26%, and the elution ratio in small intestinal fluid was 43%.

### EXAMPLE 28

A granular feed composition was obtained in the same manner as in Example 26 except that the amount of the fatty acid metal salt (product name: “Megalac”) was changed to 39.38 kg and the amount of the sorbitan tristearate having an HLB of 2.1 was changed to 8.00 kg. The granular feed composition was tested for rumen bypass properties and enteric properties. The elution ratio in rumen fluid was 12%, the elution ratio in abomasum fluid was 8%, the sum of the elution ratio in rumen fluid and the elution ratio in abomasum fluid was 20%, and the elution ratio in small intestinal fluid was 40%.

### EXAMPLE 29

A granular feed composition was obtained in the same manner as in Example 26 except that the amount of the fatty acid metal salt (product name: “Megalac”) was changed to 43.38 kg and the amount of the sorbitan tristearate having an HLB of 2.1 was changed to 4.00 kg. The granular feed composition was tested for rumen bypass properties and enteric properties. The elution ratio in rumen fluid was 18%, the elution ratio in abomasum fluid was 18%, the sum of the elution ratio in rumen fluid and the elution ratio in abomasum fluid was 36%, and the elution ratio in small intestinal fluid was 39%.

### EXAMPLE 30

A granular feed composition was obtained in the same manner as in Example 26 except that the amount of the fatty acid metal salt (product name: “Megalac”) was changed to 37.38 kg and the amount of the sorbitan tristearate having an HLB of 2.1 was changed to 10.00 kg. The granular feed composition was tested for rumen bypass properties and enteric properties. The elution ratio in rumen fluid was 11%, the elution ratio in abomasum fluid was 10%, the sum of the elution ratio in rumen fluid and the elution ratio in abomasum fluid was 21%, and the elution ratio in small intestinal fluid was 45%.

These results indicate that addition of a sorbitan fatty acid ester having an HLB of not more than 3 improves rumen bypass properties and enteric properties of a feed additive composed of an amino acid, a fatty acid metal salt and a fatty acid, and can encourage small intestine to absorb the amino acid.

1. A feed composition comprising:
an amino acid;
a fatty acid metal salt;
a fatty acid; and
a sorbitan fatty acid ester;
wherein the sorbitan fatty acid ester has a hydrophile-lipophile balance (HLB) of not more than 3.

2. The feed composition according to claim 1, wherein the amino acid is at least one selected from the group consisting of methionine and lysine.

3. The feed composition according to claim 1, wherein the fatty acid metal salt is at least one selected from the group consisting of calcium oleate, calcium myristate, calcium palmitate, calcium stearate, and calcium linoleate.

4. The feed composition according to claim 1, wherein the fatty acid is at least one selected from the group consisting of lauric acid, stearic acid, myristic acid, palmitic acid, oleic acid, and linoleic acid.

5. The feed composition according to claim 1, wherein the sorbitan fatty acid ester is sorbitan trioleate having an HLB of not more than 3.

6. The feed composition according to claim 1, wherein an amount of the amino acid is 10 to 80 parts by mass relative to 100 parts by mass of the feed composition.

7. The feed composition according to claim 1, wherein an amount of the fatty acid is 1 to 20 parts by mass relative to 100 parts by mass of the feed composition.

8. The feed composition according to claim 1, wherein an amount of the sorbitan fatty acid ester having an HLB of not more than 3 is 0.1 to 30 parts by mass relative to 100 parts by mass of the feed composition.

9. The feed composition according to claim 1, wherein an amount of the fatty acid metal salt is 10 to 60 parts by mass relative to 100 parts by mass of the feed composition.

10. A method for producing a feed composition, comprising mixing an amino acid, a fatty acid metal salt, a fatty acid, and a sorbitan fatty acid ester and shaping the resulting mixture, wherein the sorbitan fatty acid ester has a hydrophile-lipophile balance (HLB) of not more than 3.

11. The method according to claim 10, wherein the amino acid is at least one selected from the group consisting of methionine and lysine.

12. The method according to claim 10, wherein the fatty acid metal salt is at least one selected from the group consisting of calcium oleate, calcium myristate, calcium palmitate, calcium stearate, and calcium linoleate.

13. The method according to claim 10, wherein the fatty acid is at least one selected from the group consisting of lauric acid, stearic acid, myristic acid, palmitic acid, oleic acid, and linoleic acid.

14. The method according to claim 10, wherein the sorbitan fatty acid ester is sorbitan trioleate having an HLB of not more than 3.

15. The method according to claim 10, wherein an amount of the amino acid is 10 to 80 parts by mass relative to 100 parts by mass of the feed composition.

16. The method according to claim 10, wherein an amount of the fatty acid is 1 to 20 parts by mass relative to 100 parts by mass of the feed composition.

17. The method according to claim 10, wherein an amount of the sorbitan fatty acid ester having an HLB of not more than 3 is 0.1 to 30 parts by mass relative to 100 parts by mass of the feed composition.

18. The method according to claim 10, wherein an amount of the fatty acid metal salt is 10 to 60 parts by mass relative to 100 parts by mass of the feed composition.
